(19) United States
(12) Patent Application Publication
(10) Pub. No.: US 2026/0145745 A1
(43) Pub. Date: May 28, 2026

(54) VEHICLE SKELETON MEMBER

(71) Applicant: TOYOTA JIDOSHA KABUSHIKI KAISHA, Toyota-shi (JP)

(72) Inventors: Jun HAYASE, Okazaki-shi (JP); Daisuke MOTOI, Sanda-shi (JP)

(73) Assignee: TOYOTA JIDOSHA KABUSHIKI KAISHA, Toyota-shi (JP)

(21) Appl. No.: 19/177,829

(22) Filed: Apr. 14, 2025

(30) Foreign Application Priority Data
Aug. 29, 2024 (JP) 2024-148035

(51) Int. Cl. B62D 25/08

(52) U.S. Cl. CPC B62D 25/081

(57) ABSTRACT

The left and right wheel houses, the cross member, the left and right front pillars, and the cowl are integrally formed. This eliminates the joint between the cowl, the wheel house, and the cowl and the front pillar. Therefore, the work for securing the sealing property of the joint portion between the cowl, the wheel house, and the cowl and the front pillar is unnecessary.

### CROSS-REFERENCE TO RELATED APPLICATION

This application claims priority to Japanese Patent Application No. 2024-148035 filed on Aug. 29, 2024, incorporated herein by reference in its entirety.

### BACKGROUND

### 1. Technical Field

The present disclosure relates to a vehicle skeleton member.

### 2. Description of Related Art

Japanese Unexamined Patent Application Publication No. 08-282401 (JP 08-282401 A) discloses a technology related to a cowl portion of a vehicle. In this related art, a cowl welding flange is provided with a seal member in a joint structure between a cowl and a skeleton member.

### SUMMARY

The related art described above requires a process of providing a cowl welding flange with a seal member.

The present disclosure has been made in view of the above, and has an object to provide a vehicle skeleton member capable of reducing the work for securing the sealing property of a cowl.

A first aspect of the present disclosure provides a vehicle skeleton member including: a wheel house in which a wheel is disposed; a front pillar provided on a vehicle rear side of the wheel house to extend in a vehicle up-down direction, the front pillar being molded integrally with the wheel house; and a cowl that supports a front end portion of a windshield glass, the cowl being molded integrally with the wheel house and the front pillar.

The vehicle skeleton member according to the first aspect of the present disclosure includes a wheel house, a front pillar, and a cowl. The wheel house in which a wheel is disposed and the front pillar provided on the vehicle rear side of the wheel house to extend in the vehicle up-down direction are integrally molded. Further, the cowl that supports the front end portion of a windshield glass is molded integrally with the wheel house and the front pillar.

With the cowl molded integrally with the wheel house and the front pillar in this manner, there is no joint portion between the cowl and the wheel house or between the cowl and the front pillar. Therefore, the work for securing the sealing property of the joint portion between the cowl and the wheel house or between the cowl and the front pillar is not required.

A second aspect of the present disclosure provides the vehicle skeleton member according to the first aspect, further including a cross member that connects right and left wheel houses in a vehicle width direction, in which the cowl is integrally molded to include the right and left wheel houses, right and left front pillars, and the cross member.

In the vehicle skeleton member according to the second aspect of the present disclosure, a cross member that connects right and left wheel houses in the vehicle width direction is further provided, and the cowl is integrally molded to include the right and left wheel houses, right and left front pillars, and the cross member. The number of parts can be reduced in the present disclosure as compared with the case where the right and left members are separately molded and integrated by being coupled to each other after molding.

A third aspect of the present disclosure provides the vehicle skeleton member according to the first aspect, further including a cross member that connects right and left wheel houses in a vehicle width direction, in which the cowl, the right and left wheel houses, right and left front pillars, and the cross member are molded in a state of being divided at a predetermined position in the vehicle width direction, and integrated by being coupled to each other at the predetermined position.

In the vehicle skeleton member according to the third aspect of the present disclosure, a cross member that connects right and left wheel houses in the vehicle width direction is further provided. The cowl, the right and left wheel houses, the right and left front pillars, and the cross member are molded in a state of being divided in the right-left direction at a predetermined position in the vehicle width direction, and integrated by being coupled to each other at the predetermined position.

Accordingly, the mold can be made small in the present disclosure as compared with the case where the cowl, the right and left wheel houses, the right and left front pillars, and the cross member are integrally molded. In addition, the mold extraction direction may be the right-left direction of the vehicle. The mold mechanism can be simplified as compared with the case where the mold extraction direction includes the up-down direction of the vehicle.

A fourth aspect of the present disclosure provides the vehicle skeleton member according to the second aspect of the present disclosure, in which the cowl and the cross member are disposed at positions not overlapping each other in plan view.

In the vehicle skeleton member according to the fourth aspect of the present disclosure, the cowl and the cross member are disposed at positions not overlapping each other in plan view. Therefore, the mold structure can be simplified, since it is not necessary to provide a slide core or the like for forming a space between the cowl and the cross member, as compared with the case where the cowl and the cross member are disposed at positions overlapping each other in plan view as a comparative example, for example.

As described above, the vehicle skeleton member according to the present disclosure can reduce the work for securing the sealing property of a cowl.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle skeleton member according to the present embodiment is applied as viewed from a left obliquely rear side and an upper side;

FIG. 2 is a perspective view of a vehicle to which the vehicle skeleton member according to the present embodiment is applied as viewed from a right obliquely rear side and an upper side;

FIG. 3 is a perspective view of a vehicle to which the vehicle skeleton member according to the present embodiment is applied as viewed from a left obliquely front side and an upper side;

FIG. 4 is a front view of a vehicle to which the vehicle skeleton member according to the present embodiment is applied;

FIG. 5 is a cross-sectional view taken along A-A line of FIG. 1; and

FIG. 6 is a perspective view of a vehicle to which a modification of the vehicle skeleton member according to the present embodiment is applied as viewed from a left obliquely rear side and an upper side.

### DETAILED DESCRIPTION OF EMBODIMENTS

Hereinafter, a vehicle skeleton member according to an embodiment of the present disclosure will be described with reference to the drawings. Note that an arrow FR appropriately shown in the drawings indicates a front side in the vehicle front-rear direction, and an arrow UP indicates an upper side in the vehicle up-down direction. The arrow LH indicates the left side in the vehicle width direction, and in the present embodiment, indicates the outer side in the vehicle width direction. Hereinafter, in the case of simply describing the front-rear direction, the up-down direction, and the left-right direction, the front-rear direction of the vehicle front-rear direction, the up-down direction of the vehicle up-down direction, and the left-right direction of the vehicle (the vehicle width direction) are shown unless otherwise specified.

### Configuration of Vehicle Skeleton Member

First, the configuration of the vehicle skeleton member according to the present embodiment will be described.

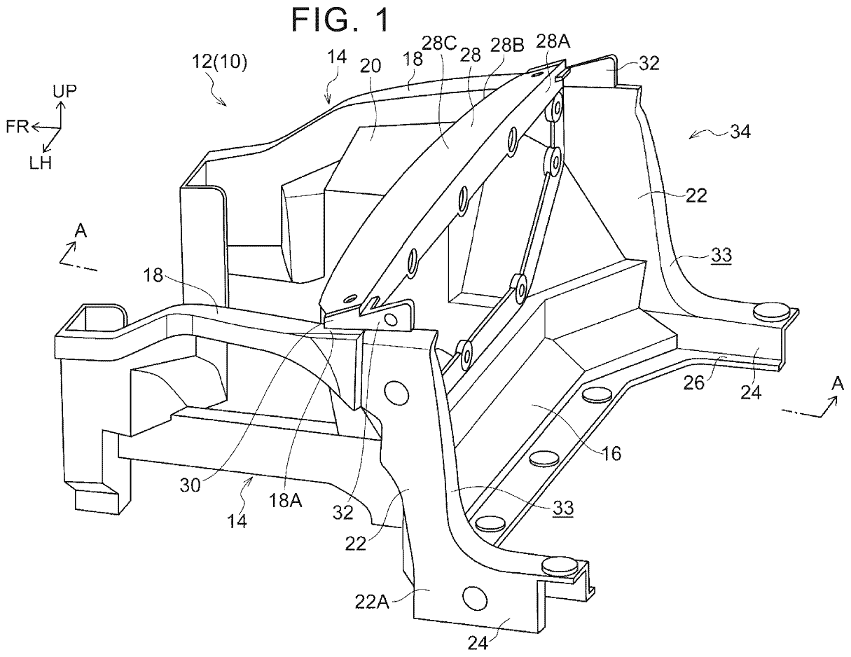

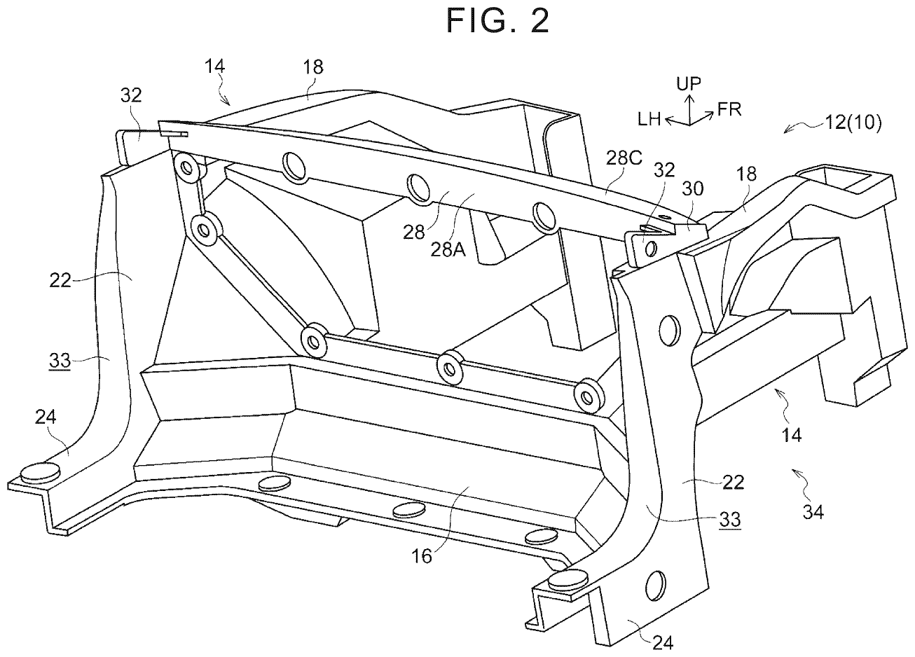

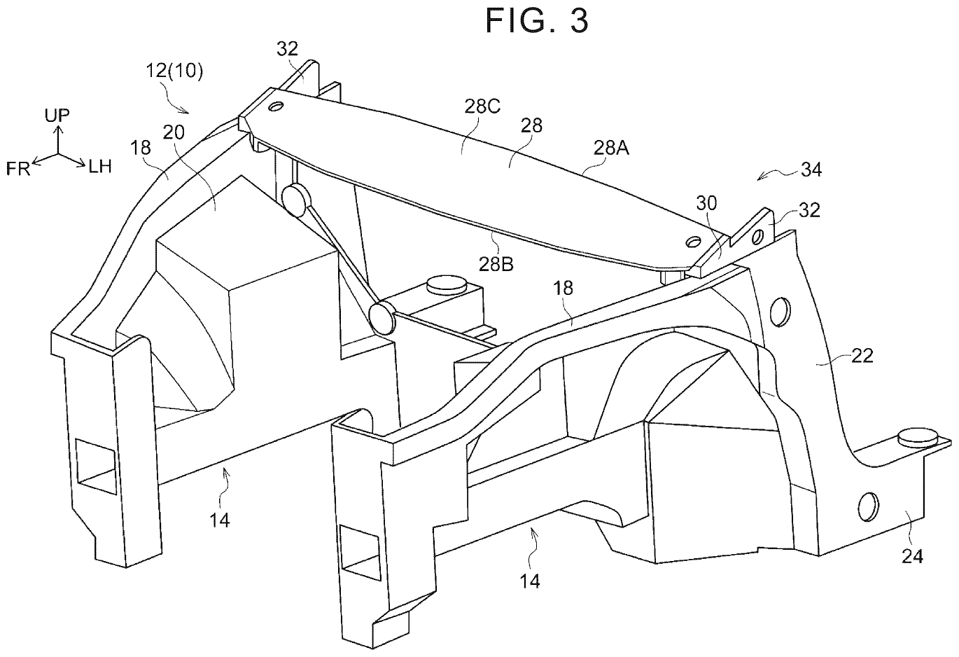

FIG. 1 to FIG. 5 show an overall view of a vehicle showing a skeleton of the vehicle 10. For example, although not shown, the vehicles 10 are a battery electric vehicle and a fuel cell electric vehicle that travel with power generated by a power unit.

As shown in FIGS. 1 to 3, the vehicle 10 to which the vehicle skeleton member 12 according to the present embodiment is applied is provided with a wheel house 14 in which wheels (not shown) are arranged on the left and right sides of the vehicle front portion. The right wheel house 14 and the left wheel house 14 are connected by a cross member 16 extending in the vehicle width direction.

An apron upper member 18 extends along the vehicle front-rear direction at an upper end of the left and right wheel houses 14, and a suspension tower 20 is provided inside the left and right apron upper members 18 in the vehicle width direction.

Front pillars 22 constituting the side portions of the vehicle front portions are provided on the rear sides of the left and right wheel houses 14. A coupling portion 24 to which a rocker (not shown) that extends in the vehicle front-rear direction and constitutes a skeleton of the vehicle body side portion is coupled is provided on a rear portion side of the lower end portion 22A of the front pillar 22.

For example, the coupling portion 24 has a substantially inverted U shape when viewed from the vehicle rear side. The rocker has a rectangular tubular shape, and the coupling portion 24 is engageable from the upper side of the rocker. With the coupling portion 24 engaged with the front end portion of the rocker, the coupling portion 24 can be coupled to the rocker from the vehicle upper side and the vehicle width direction outer side, respectively.

The shape of the coupling portion 24 is not limited to this. Further, a flange portion 26 is formed inside the coupling portion 24 in the vehicle width direction, and the flange portion 26 is coupled to an outer edge portion of a front end portion of a floor panel (not shown) by welding, fastening, or the like.

On the other hand, cowls 28 that support the front end portions of the windshield glass (not shown) extend in the vehicle width direction to the left and right apron upper members 18. In the present embodiment, the cowl 28 is disposed at a position that does not overlap the cross member 16 in plan view. The cowl 28 has a substantially arcuate shape in plan view, the rear end 28A of the cowl 28 is formed in a straight line along the vehicle width-direction, and the front end 28B of the cowl 28 is formed in an arcuate shape bulging toward the vehicle front side.

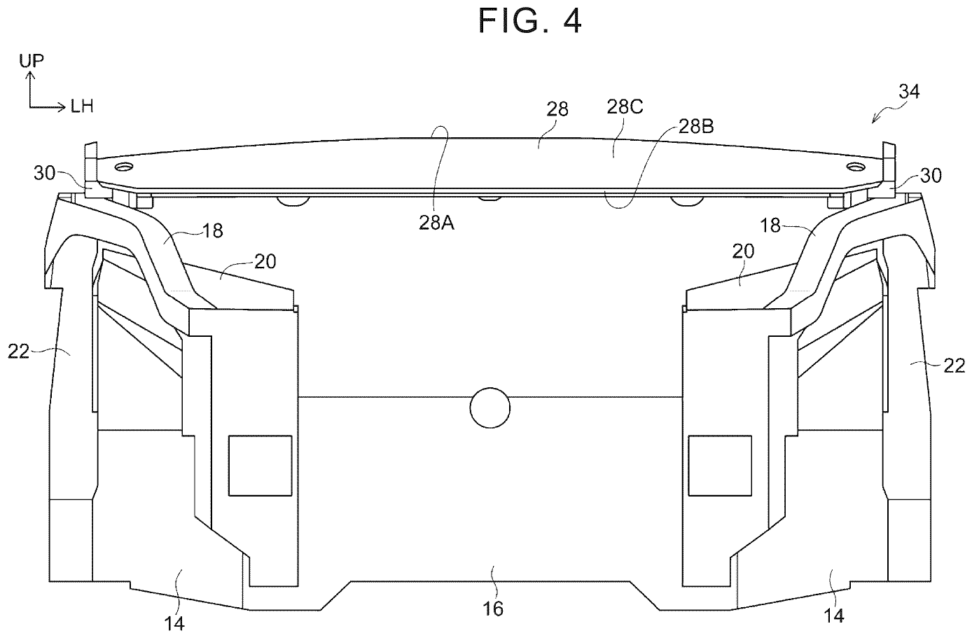

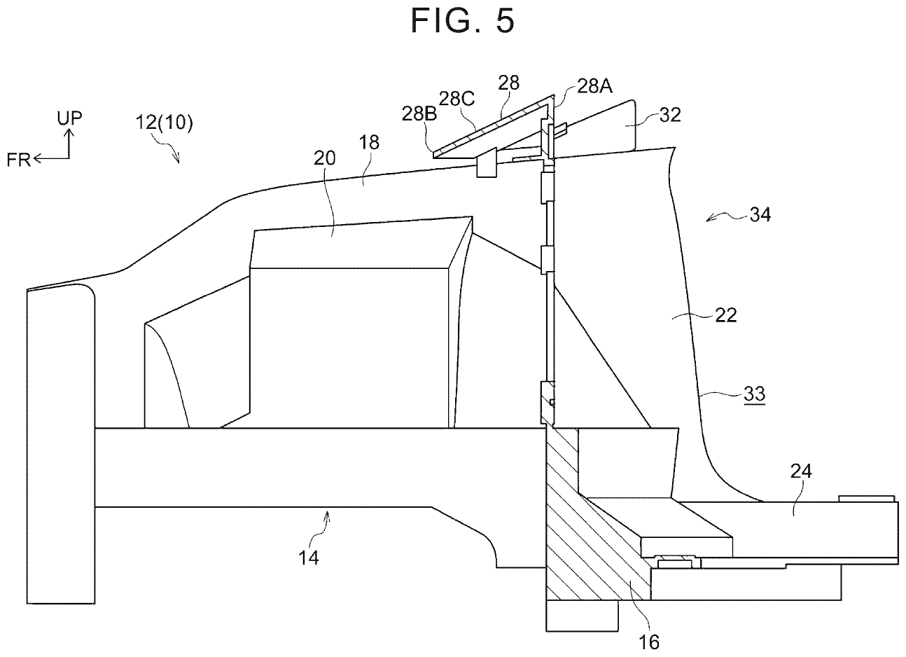

Further, as shown in FIG. 5, the upper surface 28C of the cowl 28 is inclined downward from the rear end 28A toward the front end 28B. In addition, as shown in FIG. 4, the cowl 28 is formed in an arc shape that bulges toward the vehicle upper side with the center portion in the vehicle width direction serving as a top portion.

As a result, it is possible to guide water droplets or the like flowing from the windshield glass toward the cowl 28 toward the front side of the cowl 28 or toward the outside in the vehicle width direction. Note that a groove portion through which water droplets flow may be formed on the upper surface of the cowl 28.

As shown in FIGS. 1 to 3, the cowl 28 is provided at both ends in the vehicle width direction with a connecting portion 30, and the cowl 28 and the apron upper member 18 are connected via the connecting portion 30. A mounting portion 32 connected to the upper end of the apron upper member 18 and extending toward the vehicle rear side is provided from the rear end of the connecting portion 30. Although not shown, a front pillar upper constituting an upper edge portion of the door opening 33 can be attached to the mounting portion 32.

Here, in the present embodiment, the left and right wheel houses 14, the cross member 16, the left and right front pillars 22, and the cowl 28 shown in FIG. 1 are integrally formed by casting using an aluminum alloy, a magnesium alloy, or the like as a material (integrally cast member 34).

Therefore, in the present embodiment, the wheel house 14, the cross member 16, the front pillar 22, and the cowl 28 are portions constituting a part of the integrally cast member 34. Therefore, strictly speaking, the wheel house 14 is the wheel house portion of the integrally cast member 34. The cross member 16 is a cross member portion of the integrally cast member 34. The front pillar 22 serves as a front pillar portion of the integrally cast member 34. The cowl 28 serves as a cowl portion of the integrally cast member 34. However, in the present embodiment, the effects of the wheel house 14, the cross member 16, the front pillar 22, and the cowl 28 will be described below for convenience.

### Action and Effect of Vehicle Skeleton Member

In the present embodiment, as described above, the left and right wheel houses 14, the cross member 16, the left and right front pillars 22, and the cowl 28 are integrally formed. That is, in the present embodiment, the cowl 28 is integrally formed with the left and right wheel houses 14 and the left and right front pillars 22.

Accordingly, in the present embodiment, the joint portion between the cowl 28, the wheel house 14, the cowl 28, and the front pillar 22 is eliminated. Therefore, the work for securing the sealing property of the joint portion between the cowl 28, the wheel house 14, and the cowl 28 and the front pillar 22 is unnecessary.

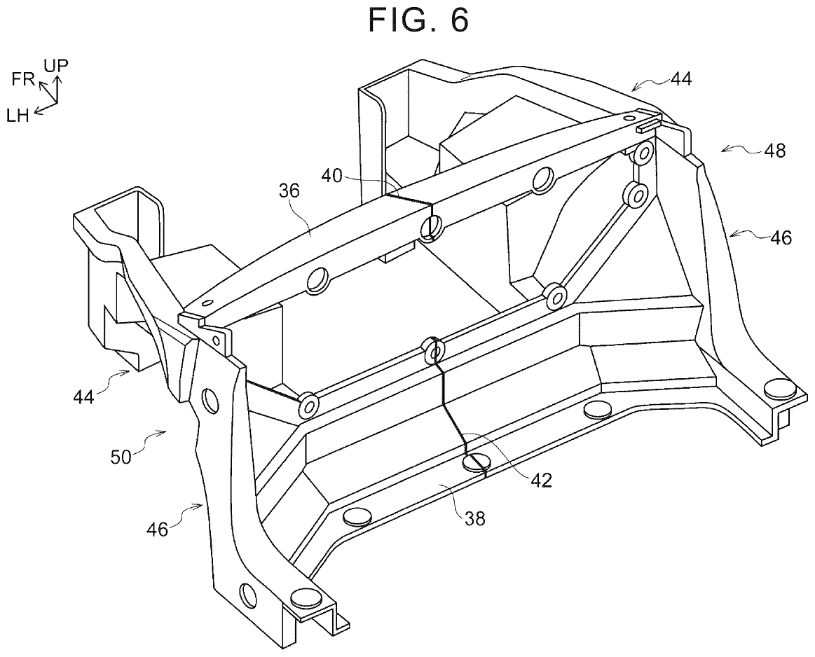

As a modification, as shown in FIG. 6, the cowl 36 and the cross member 38 may be divided by the coupling portions (predetermined positions) 40 and 42 in the vehicle width direction, respectively. The right cowl 36, the right cross member 38, the right wheel house 44 and the right front pillar 46 and the left cowl 36, the left cross member 38, the left wheel house 44 and the left front pillar 46 may be formed as the right cast member 48 and the left cast member 50, respectively.

In this case, it is necessary to join and integrate the right cast member 48 and the left cast member 50 to each other via the coupling portions 40 and 42 after molding. In the present embodiment, since the coupling portions 40 and 42 do not exist, the number of components can be reduced accordingly, and the number of assembly steps can be reduced.

However, in the present disclosure, it is sufficient that the sealing property of the joint portion between the cowl 28, the wheel house 14, and the cowl 28 and the front pillar 22 can be ensured. Therefore, as shown in FIG. 6, the right and left members are divided as the right cast member 48, the left cast member 50, the configuration for integrating the right cast member 48 and the left cast member 50 after molding, of course included in the scope of the present disclosure.

Here, in the configuration shown in FIG. 6, as shown in FIG. 1, the cowl 28, the left and right wheel houses 14, the left and right front pillars 22 and the cross member 16 as compared with the case of integrally molding, since it is divided into left and right members, it is possible to reduce the mold. Further, the die cutting direction can be the lateral direction of the vehicle 10, as compared with the case where the die cutting direction includes the vertical direction of the vehicle, it is possible to simplify the mold mechanism.

Note that, for the coupling portions 40 and 42 illustrated in FIG. 6, for example, the cowl 36, the front end of the right half of the cross member 38, the cowl 36, and the front end of the left half of the cross member 38 are coupled so as to overlap each other in the vehicle front-rear direction or the vehicle up-down direction. In addition, the cowl 36, the distal end of the right half of the cross member 38, the cowl 36, and the distal end of the left half of the cross member 38 may be joined together by separate members in a state of being in contact with each other.

On the other hand, in the present embodiment, as shown in FIG. 4, the cowl 28 and the cross member 16 are arranged at positions that do not overlap in plan view. Therefore, for example, although not shown, as compared with the case where the cowl 28 and the cross member 16 is arranged at a position overlapping in plan view, it is not necessary to provide a slide core or the like for forming a space between the cowl 28 and the cross member 16. Therefore, the mold structure can be simplified.

Although an embodiment of the present disclosure has been described above, the present disclosure is not limited to such an embodiment, and the present disclosure may be used in combination with various modifications as appropriate. Needless to say, the present disclosure can be implemented in various forms without departing from the scope of the present disclosure.

### Additional Remarks

The vehicle skeleton member according to the present disclosure may be formed by appropriately combining the following configurations.

### Configuration 1

In the vehicle skeleton member, a wheel house in which the wheels are arranged; a front pillar provided on the vehicle rear side of the wheel house and extending in the vehicle vertical direction and integrally molded with the wheel house, a cowl supporting a front end portion of the windshield glass and integrally molded with the wheel house and the front pillar is provided.

### Configuration 2

Further, a cross member connecting the left and right wheel houses in the vehicle width direction, the cowl is integrally formed including the left and right wheel houses, the left and right front pillars and the cross member.

### Configuration 3

A cross member connecting the left and right wheel houses in the vehicle width direction is further provided,

The cowl, the left and right wheel houses, the left and right front pillars, and the cross member are formed in a state of being divided at a predetermined position in the vehicle width direction, and are coupled to each other at the predetermined position to be integrated.

### Configuration 4

The cowl and the cross member are disposed at positions that do not overlap in plan view.

What is claimed is:

1. A vehicle skeleton member comprising:
a wheel house in which a wheel is disposed;
a front pillar provided on a vehicle rear side of the wheel house to extend in a vehicle up-down direction, the front pillar being molded integrally with the wheel house; and
a cowl that supports a front end portion of a windshield glass, the cowl being molded integrally with the wheel house and the front pillar.

2. The vehicle skeleton member according to claim 1, further comprising a cross member that connects right and left wheel houses in a vehicle width direction, wherein the cowl is integrally molded to include the right and left wheel houses, right and left front pillars, and the cross member.

3. The vehicle skeleton member according to claim 1, further comprising a cross member that connects right and left wheel houses in a vehicle width direction, wherein the cowl, the right and left wheel houses, right and left front pillars, and the cross member are molded in a state of being divided at a predetermined position in the vehicle width direction, and integrated by being coupled to each other at the predetermined position.

4. The vehicle skeleton member according to claim 2, wherein the cowl and the cross member are disposed at positions not overlapping each other in plan view.
